(19) United States
(12) Patent Application Publication
(10) Pub. No.: US 2004/0190872 A1
(43) Pub. Date: Sep. 30, 2004

(54) Method for local recording of television digital data

(76) Inventor: Yann Loisel, La Ciotat (FR)

Correspondence Address: Finnegan Henderson Farabow, Garrett & Dunner, 1300 I Street NW, Washigton, DC, 20005, US

(21) Appl. No.: 10/484,495

(22) PCT Filed: Jul. 23, 2002
(86) PCT No.: PCT/EP02/08207

(30) Foreign Application Priority Data
Jul. 24, 2001 (DE) 101 35 888.1

(51) Int. Cl. H04N 5/76; H04N 7/52

(52) U.S. Cl. 386/98; 348/423.1

(57) ABSTRACT

The invention concerns a method for local recording of digital data received by a transmission network, which consists in encrypting the digital data received with a local recording key (KLEA) and in locally storing the encrypted data (7). The method is characterized in that it comprises the following steps: generating a content key (CK), combining the content key (CK) and a base key (BK) to obtain the local recording key (KLEA), storing the content key (CK) and the encrypted data (7) together with the local recording key (KLEA). The invention is particularly applicable to local recording of digital data derived from digital television broadcasting.

The present invention relates to a method for local recording of digital data received from a transmission network.

It applies especially to the domain of digital television for local recording of data received by a digital transmission network, in particular by satellite or cable.

Today digital television programs are received from a transmission network at a decoder in the user premises. This decoder constitutes a conditional access device that can comprise different authorization means.

The digital data transmission is generally encrypted, to avoid any illicit use by non-authorized people.

The data are decrypted at the conditional access device level considering the authorizations accorded to the user. Such decoders generally permit direct display of the thus decrypted data flow.

As the decoder generally has no recording capability, the digital television program content is only available to be watched at broadcasting time. If the user wants to watch it at another time, it is necessary to realize a local recording respecting the constraints of re-encrypting to avoid any illicit local copy.

To address this local re-encrypting, some devices have already been proposed. Thus the documents U.S. Pat. No. 5,897,218 and FR-A-2 732 537 disclose local encrypting for recording at the decoder level or at the level of a device attached thereto. But the techniques disclosed in these documents use the same re-encryption algorithm as used for decrypting the flow received from the transmission network, so this is a proprietary and not a generalized solution.

From EP-A-0 936 812 is known a method for local recording capable to use a different local encryption algorithm.

In addition, this document proposes the use of portable devices such as e.g. chip cards for storing important encryption parameters and especially keys.

But with this the technique presented in this earlier document has the disadvantage of storing together with the locally encrypted data flow the entire key, which served for the local encryption. Sure, this key is itself encrypted by another key, but cracking the encryption of the key stored with the data allows recovering directly in clear the complete digital television program.

Consequently, none of the techniques known at the moment can give complete satisfaction about the efficiency of the local encryption performed.

The invention allows putting an end to the disadvantages of the techniques known until now.

It proposes therefore a method that allows combining at least two different keys, whereof only one is stored together with the locally stored encrypted data.

Thus a malintentioned person cannot decrypt the locally encrypted data by simply discovering the key stored with them.

Another objective of the invention is it to make a portable security module, e.g. a chip card, cooperate with a fixed device and thus to dispose of an ensemble that is more flexible in its utilization (especially in the allocation of the keys, their administration and their modification) and more secure (by suppressing the memorization and certain operations on the decoder level itself).

Another advantage of the invention is it to allow the possible combination of the local recording system with the decoder as known today for receiving the data from the transmission network, decrypting and then displaying them.

Other objectives and advantages will appear in the following description, which shows a preferred embodiment of the invention.

The present invention relates to a method for local recording of digital data received from a transmission network, which consists in encrypting the received digital data with a local recording key and in locally storing the encrypted data, characterized by the fact that

a content key is generated,

the content key is combined with a base key to obtain the local recording key,

the content key and the encrypted data are stored together with the local recording key.

According to preferred variants of this method:

the base key is stored in a portable security module,

the content key and the base key are combined in the portable security module,

the content key is signed with a signature key before being stored together with the encrypted data,

the signature key is stored in a portable security module,

the content key is generated in a random manner at every recording of a digital data flow,

the recorded digital data is displayed by:

recovery of the stored content key,

combination of the recovered content key with the base key for restoration of the local recording key,

decryption of the digital data with the local recording key,

transmission of the digital data to the display means.

the digital data are received encrypted from the transmission network and are then decrypted by a decryption algorithm,

a different encryption algorithm is used for encryption with the local recording key,

the digital data of television broadcasting is used.

The accompanying drawings are given as examples and are not limiting the invention. They represent only an embodiment of the invention and will help to understand it easily.

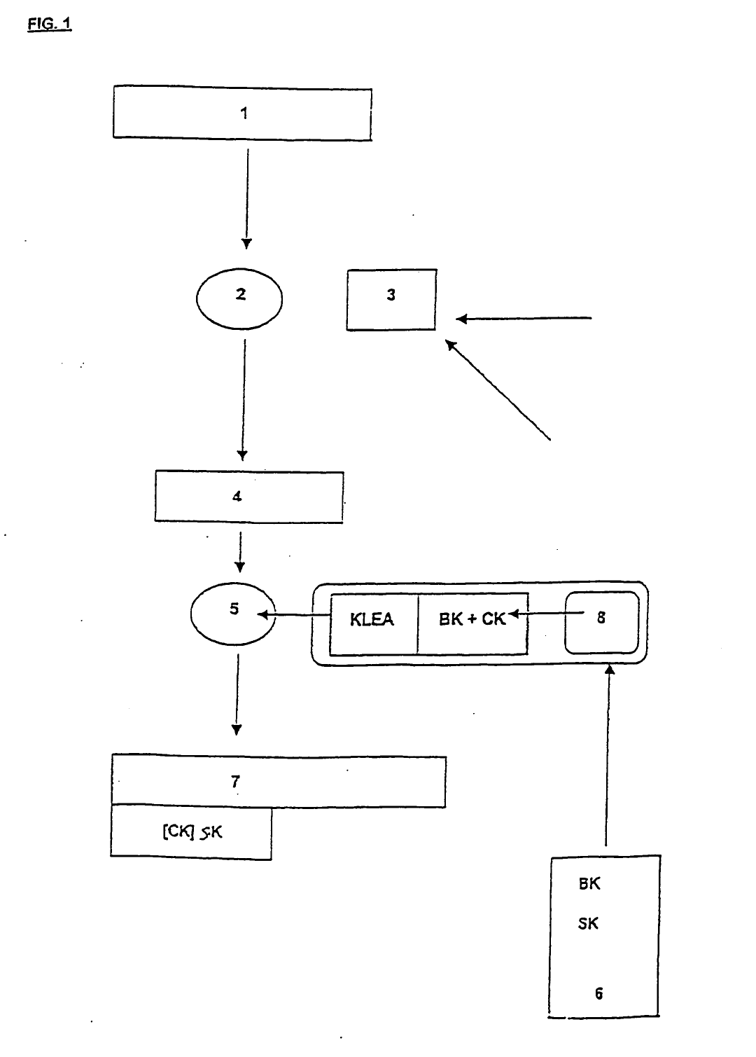

FIG. 1 is a block diagram of the steps used in the invention in a preferred embodiment,

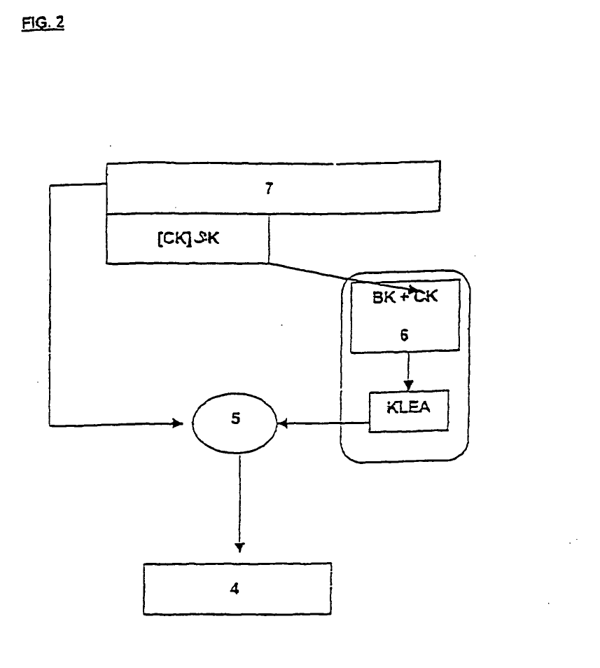

FIG. 2 shows one possibility of decryption after local encryption according to a preferred embodiment.

The method according to the invention could be used by an apparatus, which is constituted by a case enclosing different electronic means for encrypting and decrypting as well as data storing means.

Preferably, this apparatus is formed by a base comprising local encryption means as well as memory means that cooperate with one or a plurality of portable security modules 6, which are advantageously formed by chip cards that can meet known standards.

This cooperation between the apparatus base and the modules 6 will be carried out by an adapted reader.

With reference to FIG. 1, there are first illustrated the conventional and known per se phases of reception and decryption of a data flow of digital television coming from a network, e.g. a satellite network.

In this figure, the entering data 1 encrypted by the provider of the digital television program arrive at a conditional access device 2 situated in the user premises. The function of device 2 is to receive, to decrypt and to enable the display of the digital television program contained in the received data flow.

Therefore, the conditional access device 2 has different decryption means according to the user's authorizations. Preferably, the authorizations given to the user are included in the form of keys or other data in a conditional access module 3, e.g. in a chip card format. Module 3 can be read by device 2.

The entering data flow 1 can be decrypted correctly by device 2, if the authorization is true, that permits the data 4 extraction in clear.

At this level, the digital television program can be directly displayed on the screen and watched by the television viewer.

It is also possible to realize a local recording of this television program with the inventive method.

Within this scope, reference 5 in FIG. 1 represents local encryption means that allows local re-encryption of the data processed in this way. The local encryption means 5 are preferably constituted by a local algorithm of symmetrical encryption different of the one used for encryption and decryption of the entering data 1 coming from the transmission network.

The local encryption realized in this way by the means 5 utilizes a local recording key KLEA. In a manner characteristic to the invention, this local recording key KLEA is a combination of several keys and particularly of two different keys BK and CK.

The key BK is a base key that can be stored in a portable security module 6, which is appended to the basis of the local encryption apparatus. The base key BK can be reused for encryption of several digital television programs. Storing on a portable security module as for example a chip card has the advantage to avoid communication of the key to the basis of the local encryption and recording apparatus. Of course, it can be possible to update the base key BK by transmissions over the transmission network for the digital television broadcasting. Other forms of update are possible as well and also the possibility to use several base keys BK according to the digital television programs suppliers.

To realize the local recording key KLEA, the base key BK is combined with another key called content key CK. Preferably, the content key is modified at every process of locally storing a digital television program.

According to the inventive process, the key CK is generated by a generator 8, preferably in a random manner.

Then the content key CK which consist of a random number is combined with the base key BK to get the local recording key KLEA which serves for local encrypting of the data.

It is then possible to store locally in an adapted memory the digital data flow, encrypted by the key KLEA by the local encryption means 5, as well as the content key CK.

For an even greater protection against piracy, the content key CK may be stored with the thus encrypted digital data flow 7 after being signed with a signature key SK.

Advantageously, the signature key SK is also stored in a portable security module 6.

In a preferred manner, the step of combining the base key BK with the content key CK is performed in the portable security module 6 to avoid transmission of base key BK in clear. The random generation of content key CK may be performed at the apparatus base or in the portable security module 6. The generator 8 of the random number will be positioned consequently.

As shown in FIG. 1, the process results in a local recording of encrypted data 7 together with the content key CK, which is only part of key KLEA that permitted the encryption.

Of course, other data may be stored as well, especially transmission characteristics (especially the transmission date).

To realize decryption and display of encrypted data 7, it is possible to follow the steps illustrated in FIG. 2.

In this figure, content key CK is directly recovered together with the encrypted data 7, and the signature is verified with the signature key SK, that served for its signature.

Thus the content key CK is recovered by the portable security module 6 and may be recombined with the base key BK. With this new combination the local recording key KLEA may be reconstituted.

The latter is then transmitted to the local encryption means 5 to realize a decryption of the data 7.

In this manner the data 4 are recovered in clear for being displayed.

1. Method for local recording of digital data received from a transmission network, which consists in encrypting the received digital data with a local recording key (KLEA) and in locally storing the encrypted data (7), characterized by the fact that
a content key (CK) is generated,
the content key (CK) is combined with a base key (BK) to obtain the local recording key (KLEA),
the content key (CK) and the encrypted data (7) are stored together with the local recording key (KLEA).

2. The method of claim 1, characterized by the fact that the base key (BK) is stored in a portable security module.

3. The method of claim 2, characterized by the fact that the content key (CK) and the base key (BK) are combined in the portable security module (6).

4. The method according to any of the claims 1 to 3, characterized by the fact that the content key (CK) is signed with a signature key (SK) before being stored together with the encrypted data (7).

5. The method of claim 4, characterized by the fact that the signature key (SK) is stored in a portable security module (6).

6. The method according to any of the claims 1 to 5, characterized by the fact that the content key is generated in a random manner at every recording of a digital data flow.

7. The method according to any of the claims 1 to 6, characterized by the fact that the recorded digital data is displayed by:
recovery of the stored content key (CK),
verification of the signature with the signature key (SK),
combination of the recovered content key (CK) with the base key (BK) for restoration of the local recording key (KLEA),
decryption of the digital data (7) with the local recording key (KLEA),
transmission of the digital data to the display means.

8. The method according to any of the claims 1 to 7, characterized by the fact
that the digital data are received encrypted from the transmission network and are then decrypted by a decryption algorithm,
that a different encryption algorithm is used for encryption with the local recording key (KLEA).

9. The method according to any of the claims 1 to 8, characterized by the fact that the digital data of television broadcasting is used.
